(19) United States
(12) Patent Application Publication
(10) Pub. No.: US 2014/0081732 A1
(43) Pub. Date: Mar. 20, 2014

(54) INCENTIVIZED, AUTHENTICATED PRESENCE VERIFIED PROSPECT AGGREGATOR

(71) Applicants: David Allen Farmer, Tampa, FL (US); Michael Patrick Martin, Tampa, FL (US)

(72) Inventors: David Allen Farmer, Tampa, FL (US); Michael Patrick Martin, Tampa, FL (US)

(73) Assignee: INTICE, INC., Tampa, FL (US)

(21) Appl. No.: 13/618,576

(22) Filed: Sep. 14, 2012

(51) Int. Cl. G06Q 30/02

(52) U.S. Cl. 705/14.26

(57) ABSTRACT

A computer implemented method for inducing customers to visit a retail establishment to engage in a financial transaction. An offer to redeem a stored value payment card dependent upon visiting the retail establishment is displayed on a first computer to an end user. Personal user information is gathered and a unique redemption PIN is created. A second computer displays to a retailer at the physical retail establishment a retailer interface used for validating the unique redemption PIN. Upon visiting the physical retail establishment the end user validates the redemption PIN. The retailer interface received a mailing address from end user and mails a stored value payment card to the end user. End user activates the stored value payment card by visiting a unique URL and answering questions associated with their visit.

### BACKGROUND OF THE INVENTION

1. Field of the Invention

This invention relates to an incentivized prospect aggregator network architecture. More specifically, it relates to a computer-implemented method for incentivizing customers to visit a retail establishment in order to engage in a financial transaction.

2. Brief Description of the Related Art

Advertising is an extremely competitive and profitable field for businesses. Businesses are constantly seeking new ways to advertise and reach customers. Traditionally, advertisements were found on written media or television commercials, but advancement in technology has led to many innovations in the field of advertising. Customers can now be reached on computers, portable electronic devices, and social media, among others. There exists a need for a method that can increase prospective customer traffic at a physical retail establishment and increase conversion rate of a prospective customer to a purchasing customer.

One method is to improve customer attentiveness to the advertisement. An example of this method is described in US Pat. App. 2006/0224452 A1 to Gene Ng. Gene application describes a method that involves viewing a specific advertisement and answering a series of questions associated with the advertisement. Correct answers award a prospective customer with various rewards. An advantage associated with this method is that it requires potential customers to concentrate on and retain the details of the advertisement, which may solidify the message in the customers mind. Despite the advantage, this method has several disadvantages associated with it. First, customers may be discouraged by being forced to remember key facts and answer questions associated with an advertisement. Second, this method lacks a way of keeping track of whether customers actually purchased products relating to the advertisement. Finally, this method does not require a customer to actually shop or further look into the advertiser's goods or services.

Another method is to provide advertisements to a potential customer about the product the customer is using. US Pub. No. 2008/0319845 to Adkins et al., is an example of this type of advertising. Adkins discloses a method of providing a customer of printing services with advertisements related to the printer as the customer is using its services. An example of this method would be providing a printout advertisement of where to buy ink cartridges when the customer is using the printer. Advertising this way provides highly relevant ads to potential customers, but suffers from several drawbacks. First, it does not require a customer to shop or further look into the advertiser's goods or services. Second, it fails to provide an incentive for a potential customer considering the goods or services. Finally, this method lacks a way of keeping track of whether the prospective customer became a purchasing customer.

In an effort to build upon advertising methods, such as that described by the Adkins application, some advertisers use incentives for viewing advertisements and providing a link to purchase goods and services related to the advertisement. An example of this methodology is substantially described in US Pub. No. 2002/0055871 A1, to Gabler. Gabler describes a method where a customer creates a profile that associates the customer with advertising preferences. A customer receives advertising content based upon preferences and can receive incentives, such as entering into sweepstakes, for viewing the advertisement. Additionally, a customer may be given a link to the advertiser's website in which they may purchase the goods or services associated with the advertisement. While this type of method is advantageous, it presents several drawbacks. First, like the other examples, a user is not actually encouraged to shop or further look into the advertiser's goods and services to receive an incentive. Second, there lacks a way of tracking whether or not the incentive was successful. Finally, there lacks a way of keeping track of the expenses associated with providing the incentives.

There exists a need for an incentivized prospect aggregator that is based upon the authenticated presence of the potential customer at the physical business. There also exists a need for tracking expenditures on advertising incentives and whether the incentive resulted in a purchasing customer. However, in view of the art considered as a whole at the time the present invention was made, it was not obvious to those of ordinary skill in the field of this invention how the shortcomings of the prior art could be overcome.

### BRIEF SUMMARY OF THE INVENTION

The long-standing but heretofore unfulfilled need for an incentivized, authenticated presence verified prospect aggregator is now met by a new, useful, and nonobvious invention.

The novel computer implemented method includes inducing a customer to visit a physical retail establishment to engage in a financial transaction. An offer to redeem a stored value payment card in exchange for an authenticated visit to a retail establishment is displayed on a customer's computing device when they visit a business's webpage. A customer is issued a unique redemption PIN responsive to an indication they will accept the offer. Displayed on a second computing device is a retailer interface used for validating the redemption PIN when the customer visits the physical retail establishment. The retail interface collects predetermined personal information from a customer when they validate their redemption PIN. Personal information may include a mailing address for the incentive to be shipped to. A stored value card is then shipped to the customer. Upon receiving the stored value card the customer is presented with a survey on their computing device. The survey is associated with the retail establishment the customer visited. Responses to the survey are tracked to determine whether a financial transaction was executed. In a preferred embodiment the retail establishment is a car dealership.

In an alternative embodiment tracking PINs are placed throughout the interaction to determine customer responses. Additionally, the customer's IP address may be captured upon visiting the retail establishment's webpage. A computer based server compares the IP address to a stored list of IP addresses to determine whether customer has already registered for the offer. Responsive to a comparison not resulting in a match the offer is displayed on the customer's computer. The customer may decide to decline the offer which moves the offer to the side of the customer's graphical user interface. This minimized offer may be selected at a later time.

In an alternative embodiment the method further comprises opening a new browser interface responsive to customer accepting the offer. Upon opening the new browser interface the user is asked to input personal information, such as name, phone number and e-mail address, prior to receiving the redemption PIN. Upon entering the information the customer's e-mail address is compared to a stored list of registered e-mail addresses to determine whether it has been previously registered. If the comparison does not result in a match a redemption PIN is created and associated with the customer's personal information. A redemption certificate is then displayed on a graphical user interface. An ADF XML e-mail may be sent to a retail establishment's CRM tool containing customer information and customer's redemption PIN.

The method of validating the redemption PIN may further comprise having the customer physically go into a dealership with the redemption certificate. Dealership then logs onto a computer based server and inputs customer's name and redemption PIN. A computer based server then compares the redemption PIN to a stored list of previous registered customer names and redemption PINs. If the comparison results in a match the dealer selects the match and inputs the customer's mailing address. The mailing address is verified through USPS web tools verification API. If the address is verified, a stored value payment card for a specified amount is ordered through API integration with VISA.

The steps of creating the stored value payment card may include setting up a dealer's account to a computer based server and adding funds to the dealer's account. Dealer then inputs an order for creating an incentivized card based upon validation of a redemption PIN. The dealer's account is then debited for the specific amount of the stored value payment card. When the dealer reaches specific remaining balance amounts notices are sent to remind dealer to add funds. If the dealer's account ever reaches zero the offer is no longer displayed on the dealer's webpage.

Activation of the stored value payment card can include the steps of receiving the stored value payment card in the mail, wherein the stored value payment card contains an activation PIN with a customized URL. Customer then inputs the customized URL into an internet browser interface. After reaching the custom URL, an activation PIN corresponding to the stored value payment card is input into the browser interface. The activation PIN may be the card number associated with the stored value payment card. Customer is then presented with several questions that must be answered prior to activation of the stored value payment card. Once questions are responded to an activate message is sent through API call to VISA activating the stored value payment card.

### BRIEF DESCRIPTION OF THE DRAWINGS

For a fuller understanding of the invention, reference should be made to the following detailed description, taken in connection with the accompanying drawings, in which:

FIG. 1 is a flowchart of the method of creating a redemption certificate for use in accordance with an embodiment of the present in invention;

FIG. 2 is a flowchart of the method of redeeming a redemption certificate for use in accordance with an embodiment of the present in invention;

FIG. 3 is a flowchart of a method of activating a stored value payment card in accordance with an embodiment of the present in invention;

FIG. 4 is an exemplary block diagram of the graphical user interaction of the components used to provide an incentivized presence aggregator in accordance with an embodiment of the present in invention.

FIG. 5 is an exemplary block diagram of the graphical user interaction of the components used to provide an incentivized presence aggregator in accordance with an embodiment of the present in invention.

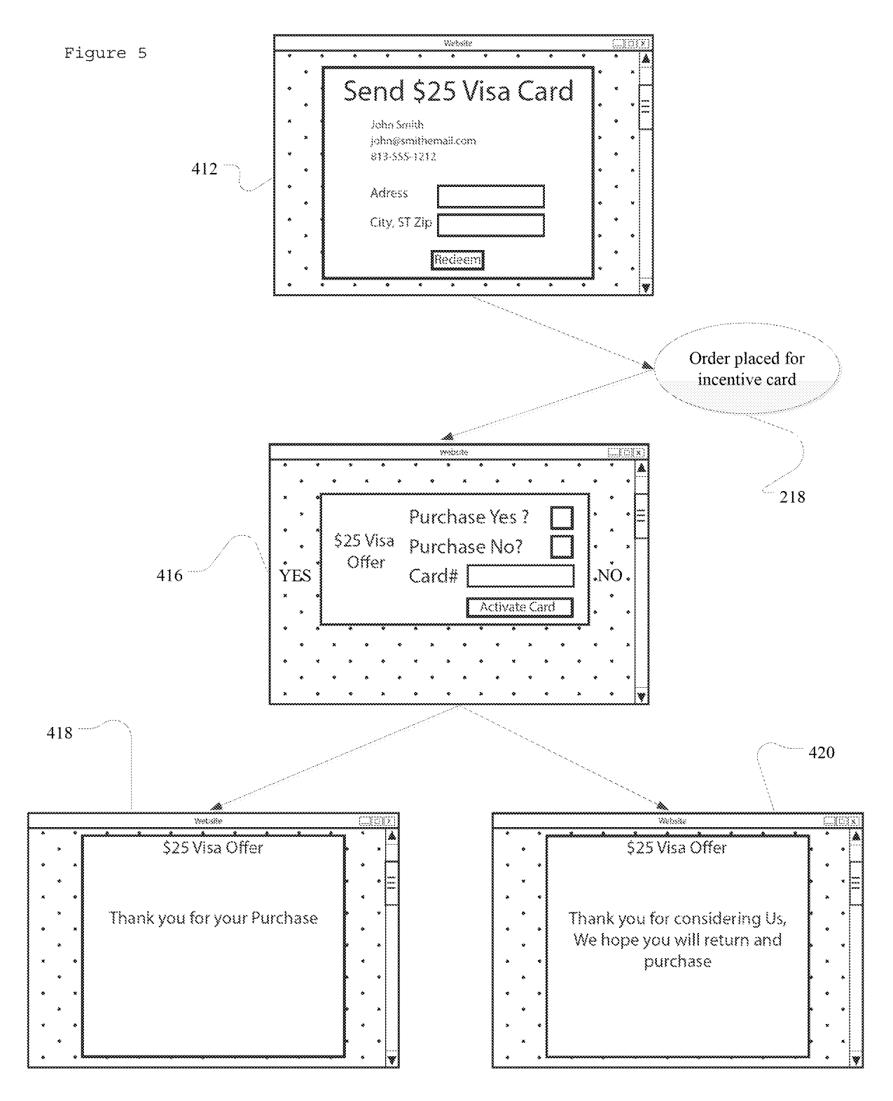

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The present invention includes a method of incentivized, authenticated presence verified aggregator for use in retail sale and advertising. Responsive to information received through a retail store's browser interface a user may receive an incentive for physically visiting the retail location.

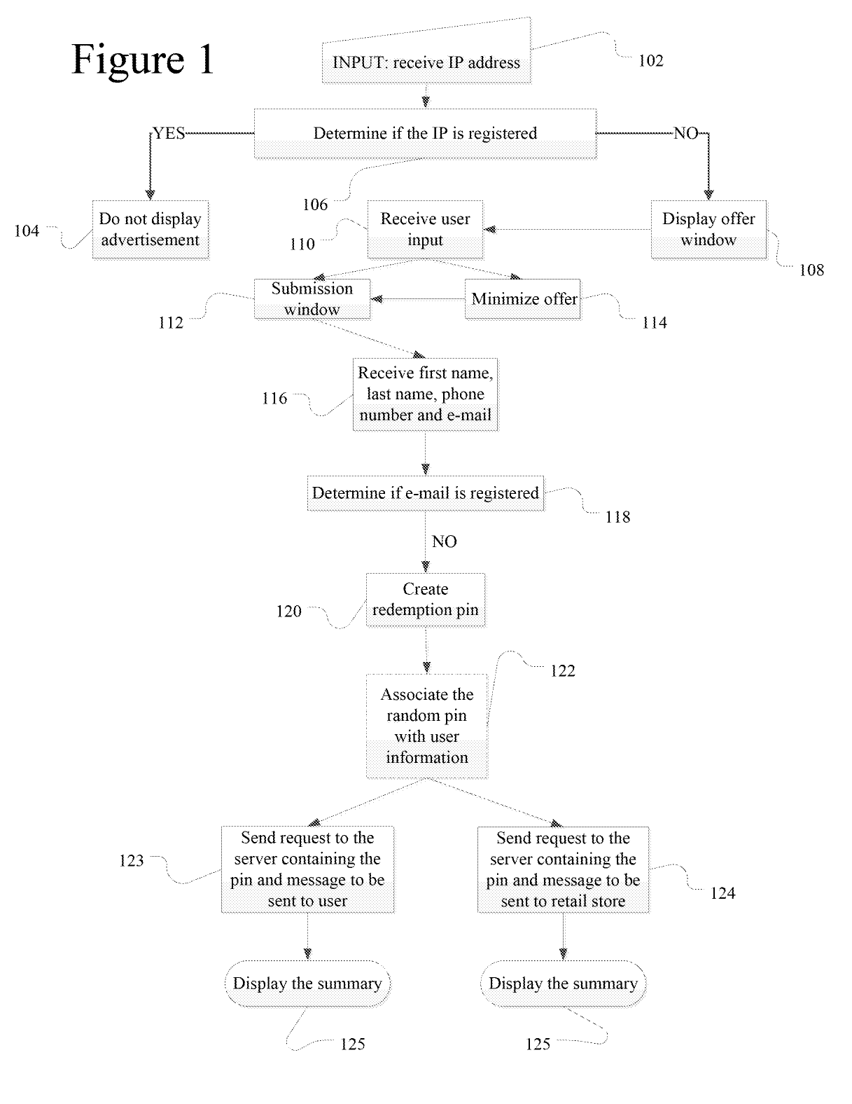

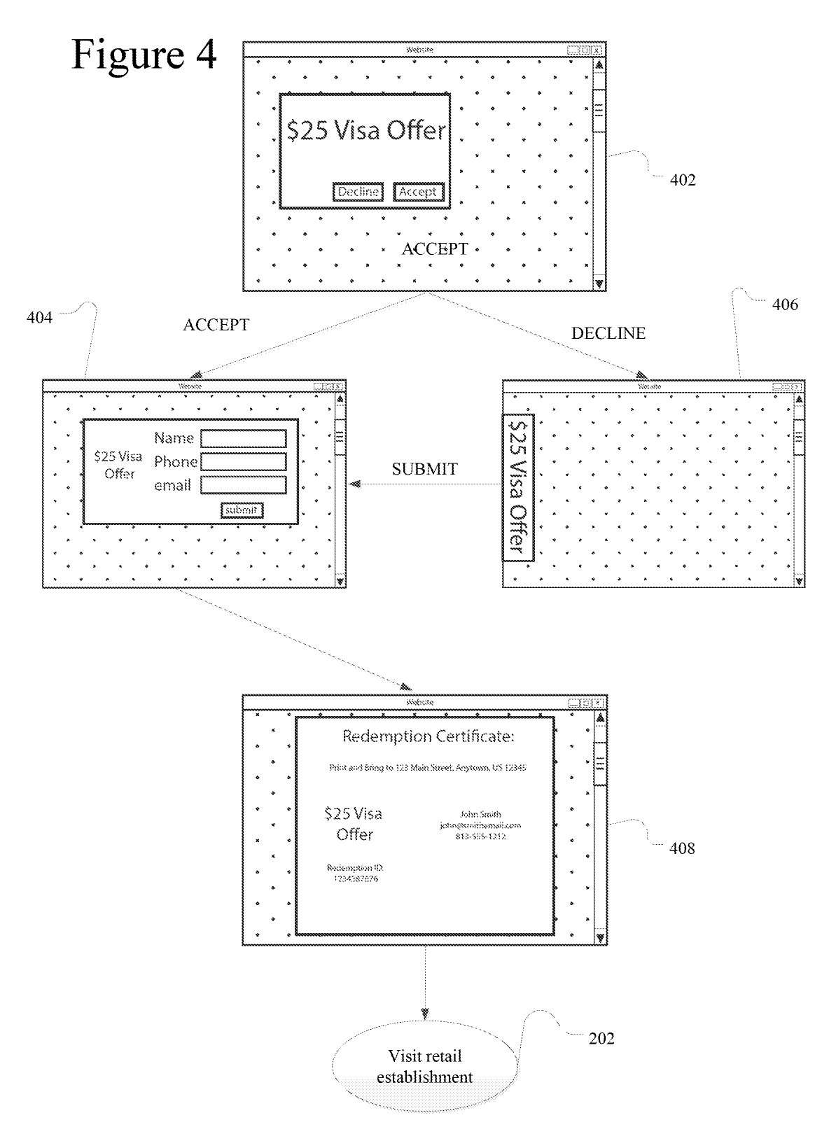

The method includes having a customer visit a retail establishment's webpage and respond to a presence authenticator offer, which is illustrated in FIG. 1. Throughout the detailed description reference should be made FIG. 4, which illustrates examples graphical user interfaces. A retail establishment creates a JavaScript on their webpage. When a customer visits a webpage with the JavaScript a computer based server receives an IP address (operation 102) of user visiting the webpage. The IP address is compared to a stored list of registered IP addresses that have already registered (operation 106). If the comparison found no match an offer window 402 appears on visitor's web browser (operation 108). Offer window 402 indicates that visitor can receive an incentive for considering the retail establishment. For example, offer window 402 can indicate customer will receive “a customized dealership pre-paid visa debit card.” In a preferred embodiment the retail establishment is a business that relies on in person customer traffic for sales, such as car dealerships.

Once offer window 402 is displayed the customer can choose to select or to minimize offer window 402 (operation 110). Offer window 402 is minimized responsive to a customer selecting to close or minimize offer window 406 (operation 114). If the offer window is minimized 406 or closed a small tab is placed on either the right, left, or bottom of the browser window. The minimized offer window 406 may be selected at a later time by customer. If customer selects offer window, whether full or minimized, a submission window 404 will appear (operation 112).

The submission window 404 will ask for identification information, which may include a first name, last name, e-mail address and a phone number. A computer based server will receive the user's first name, last name, e-mail address, and phone number (operation 116). The e-mail address is compared to a stored list of registered e-mail addresses (operation 118). If the comparison does not result in a match a unique redemption PIN is created (operation 120) and associated with the identification information received (operation 122). The PIN may be any combination of numbers or letters that creates a unique identifier. In a preferred embodiment the customer's IP address is captured and associated with the unique PIN (operation 122). A request is sent to the server containing the redemption PIN and message to be sent to user (operation 123). A redemption certificate 408 is then displayed on a customer's graphical user interface (operation 125). Additionally, a message is sent to the customer containing the redemption certificate 408 and directions on how to redeem the certificate. If the comparison results in a match no redemption certificate is created and customer may receive a message indicating the e-mail address is already registered. In a preferred embodiment the redemption certificate 408 contains the unique redemption PIN and information on how to redeem the certificate. At the same time the customer is presented with the redemption certificate, a request is sent to the server containing the PIN and a message to be sent to the retail store (operation 124). A message is sent to the retail establishment with the customer information and displayed on their computers (operation 125). In a preferred embodiment an ADF XML email is sent to a dealership CRM tool.

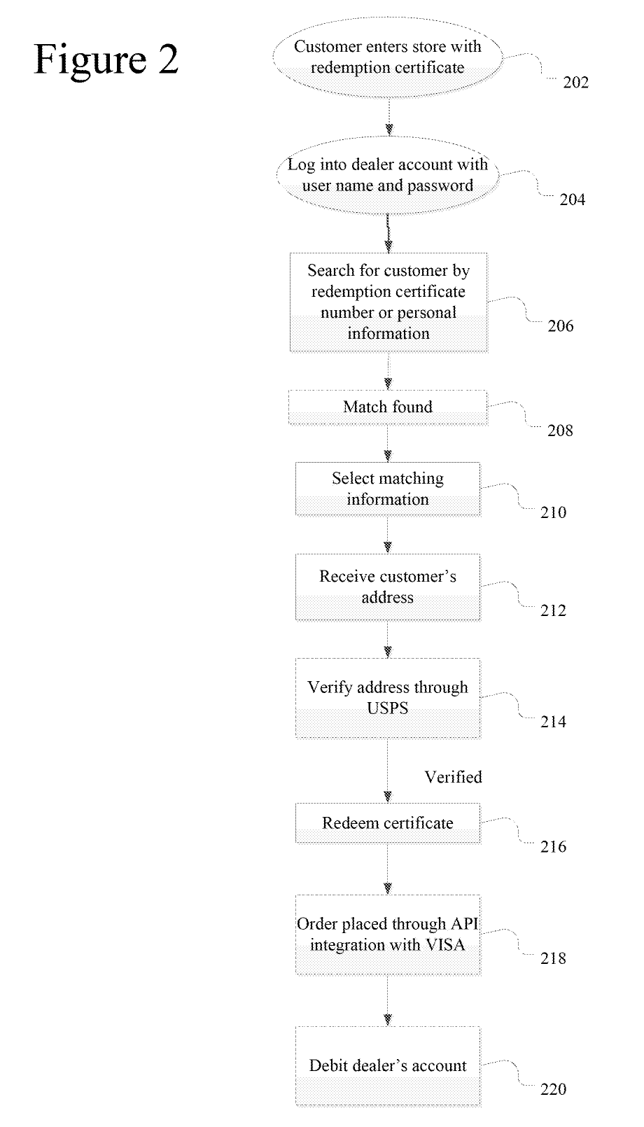

FIG. 2 illustrates the steps involved in redeeming the redemption certificate. Redeeming the redemption certificate begins when a registered customer visits the participating retail establishment (operation 202). An employee of the retail establishment logs onto a computer based server through use of their specific user name and password (operation 204). In a preferred embodiment an employee logs onto http://tools.inticeinc.com. Once the retail employee has logged on they are presented with a list of all customers that have registered online. The list of all registered customers can be searched through any of the personal identification information entered when registering or the unique redemption PIN (operation 206). Matches are displayed on a graphical user interface and selectable by the retail employee (operation 208). Retail employee then selects the registered customer that matches the customer visiting the retail establishment (operation 210).

Once the customer is selected from a list of registered customers the retail employee is prompted 412 to enter the address that the customer would like the incentive to be sent to (operation 212). In a preferred embodiment the address is verified through the USPS web tools verification API to confirm that the address is accurate (operation 214). When the information is entered and verified the retail employee completes validation by submitting the information (operation 216). The program will then order a stored value payment card through API integration with VISA for a specified amount (operation 218). Cost of the VISA card is debited from retail establishment's account (operation 220).

When setting up an account through the incentive program a retail establishment adds funds. Funds are debited from the account each time an order is placed for a new card. Each of the transactions are later viewable through a transaction report page that details the amount debited, date and the remaining balance amount. A retail establishment may add funds to their existing account by logging into their account and entering the appropriate information. Additionally, a message is sent to the retail establishment when the account reaches specific amounts. For example, when an account reaches a dollar amount equal to 10 cards, an automated e-mail is sent to the retail establishment's email address. Another message is sent at 5 cards, 2 cards, and 1 card. When the balance reaches zero the system automatically suspends the offer window from appearing on the dealer's website and the retail establishment may no longer redeem the customer's certificates. The message may be an e-mail message that contains a reminder message to re-charge the balance and a link to where the dealer may add funds to their balance.

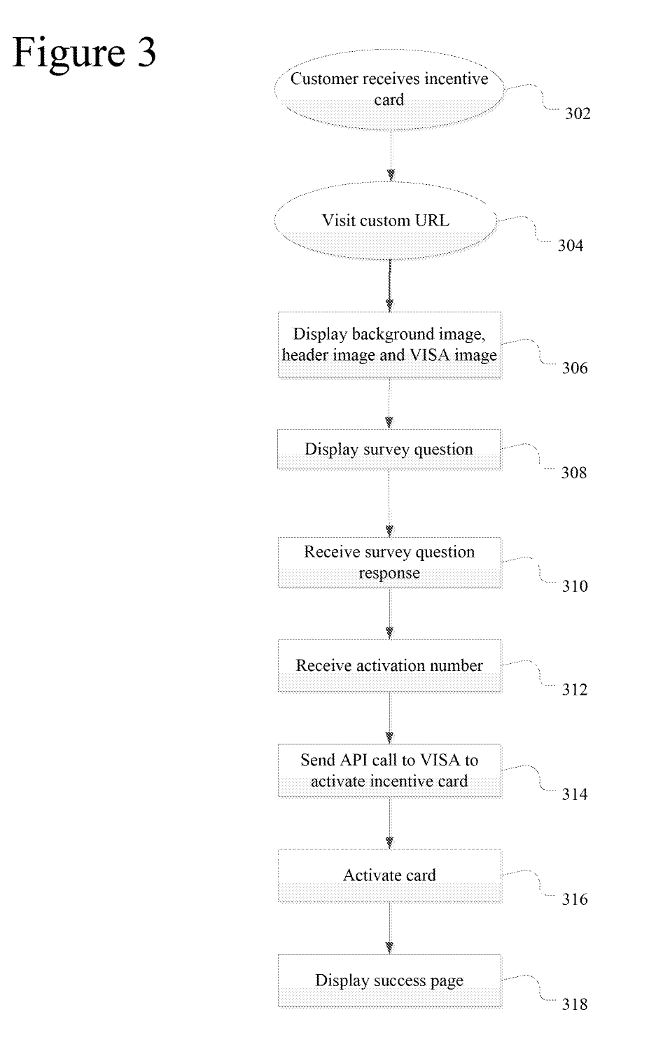

FIG. 3 illustrates the method of activating the stored value payment card. After the customer leaves the retail establishment the incentive VISA card will generally arrive within 4-7 days after the visit (operation 302). Preferably, the incentive VISA card is mailed by USPS, first class. When the customer receives the incentive VISA card they must activate the card in order to use it. Affixed to the stored value payment card is an activation label with a customized URL that the customer has to visit to activate their card. An example would be: http://www.MyRewardCard.net/inticetoyotaz. The activation website 416 is generated through software by uploading a background image, header image and VISA image. When the customer visits the site (operation 304) they are presented with the uploaded background, header image and VISA image (operation 306). A survey question is then displayed which must answer prior to activating the card (operation 308). The question is associated with the retail establishment the customer received their card from. An example question is “did you purchase anything during your visit?” Once the customer answers the question (operation 310), enters their VISA card number (operation 312) they click the “Activate My Card” button. Through an API call the VISA card is activated (operations 314+316).

In a preferred embodiment the customer is presented with a success page after activation (operation 318). The success page may indicate a message responsive to the question presented when the customer activated the card. For example, the question may ask whether the customer purchased from the retail establishment. A “thank you” page 418 could be displayed responsive to an indication that the customer purchased. Alternatively, a “visit again” page 420 could be displayed responsive to an indication that the customer did not purchase. In addition, the success page may contain a review submission form, and a link to a fan page for the retail establishment.

In another preferred embodiment the customer receives a series of e-mails after registering their e-mail address (operation 116). The e-mails can be directed at advertisements relating to the dealership, reminders about redeeming the offer, or other advertisements which may be relevant to the customer. E-mails are interspersed throughout a pre-determined period of time from when the customer registers. For example, a retail establishment may make the offer good for sixty (60) days after a customer registers. During the sixty (60) day period the customer will receive an e-mail once a week to their registered e-mail address.

In an alternative embodiment the method may include storing a series of e-mail templates on a computer based server. The retail establishment can access these templates by logging into their unique user account. Once logged in, a retail establishment may select from a series of templates which they can customize. A computer based server receives the e-mail and generates a series of messages using the personal information gathered during the sign-up process (operation 116). This allows for each e-mail to be customized for every registered customer. The personal information may include the customer's name, e-mail address, and unique redemption code. Once the message is generated the computer based server sends the message to the registered customers.

In an alternative embodiment tracking PINs may be interspersed throughout the method. A first tracking PIN may be placed on the webpage upon first visiting the business's webpage. The first tracking PIN may be used to retarget future GOOGLE® advertising towards the customer. Another tracking PIN may be placed to determine customer's response to the advertisement, i.e. accept or decline. A third tracking PIN may be placed on a customer's webpage when they accept the advertising offer to determine whether the customer converted to a lead. Fourth and fifth tracking PINS may be placed on the unique URL activation webpage. Each PIN associated with a specific customer response to the activation question. Finally, GOOGLE® advertisements may be directed towards customer's interest upon an indication a purchase was not made. It is also possible to direct various advertisements responsive to a variety of answers given in the survey questions.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program PIN embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program PIN embodied on a computer readable medium may be transmitted using any appropriate medium, including but not limited to wireless, wire-line, optical fiber cable, radio frequency, etc., or any suitable combination of the foregoing. Computer program PIN for carrying out operations for aspects of the present invention may be written in any combination of one or more programming languages, including an object oriented programming language such as Java, C#, C++ or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### GLOSSARY OF CLAIM TERMS

Activating: to make something active or operative.

ADF XML: Stands for Auto Dealer Format. It is a type of XML format that car dealerships receive for their inbound leads from websites into their ISM (Internet Sales Management tool).

API: stands for Application Programming Interface. It is a specification intended to be used as an interface by software components to communicate with each other.

CRM tool: stands for Customer Relationship Management tool. There are a wide variety of CRM tools that involve organizing, automating and synchronizing business processes.

Computing device: general purpose device used to carry out a finite set of arithmetic or logical operations.

Debiting: removing a specified monetary amount from one entity to another entity.

End user: person or individual who uses a product.

Financial Transaction: an agreement, communication, or movement carried out between a buyer and seller to exchange goods or services for a payment.

Graphical user interface: a type of user interface that allows users to interact with electronic devices.

Internet Browser: a software application for presenting, retrieving and traversing information resources on the World Wide Web.

IP address: stands for Internet Protocol address. It is a combination of numerical numbers assigned to devices participating in a computer network that uses internet protocol for communication.

Message: generally means an object of communication or vessel which provides information. This can include, but is not limited to, SMS, e-mail, or voicemail.

Offer: a proposal for engaging in a specific behavior.

Personal information: information that can be used to uniquely identify, contact, or locate a single person or can be used with other sources to uniquely identify a single individual.

PIN: stands for personal identification number. Generally, a PIN is a series of numbers and letters that are used to identify or associated with a specific entity or subject.

Redeem: to recover or gain ownership through performing a specific task.

Retail establishment: is a place to engage in the sale of retail. Retail is the sale of goods or services from individuals or businesses to an end user.

Retail interface: a type of user interface used by retailers to interact with electronic devices.

Sidebar display: a display located on a side of a graphical user interface.

Stored value payment card: refers to a monetary value stored on a card that is not related to an individual's personal bank account. This definition shall include pre-paid debit cards, closed system pre-paid cards, semi-closed system pre-paid cards, and open system pre-paid cards.

Survey: a series of questions or statements directed towards obtaining information.

Targeted advertising: directing information, data, questions, advertisements or other material relevant to an individual determined by pre-determined criteria.

Targeted placement: directing information, data, questions, advertisements or other material relevant to an individual determined by pre-determined criteria.

Tracking information: personal information which can be used to identify a specific individual or source.

USPS: stands for United States Postal Service. The USPS is an independent agency of the United States government responsible for providing postal services.

Validation: procedures used to verify a product, service, materials or event have occurred or are met based upon pre-determined criteria.

XML: Stands for extensible markup language. It is a markup language that defines a set of rules for encoding documents in a format that is both human readable and machine readable.

What is claimed is:

1. A computer implemented method for inducing customers to visit a physical retail establishment to engage in a financial transaction, comprising:
displaying on a first computing device to an end user an offer to redeem a stored value payment card in exchange for an authenticated visit to the physical retail establishment;
automatically receiving end user tracking information via the first computing device, the end user tracking including IP address information;
saving the end user tracking information as a tracking record;
issuing a unique redemption PIN to the end user identifying the end user with the tracking record through the first computing device;
displaying on a second computing device to a retailer at the physical retail establishment a retailer interface wherein the unique redemption PIN is validated confirming the end user's visit to the physical retail establishment;
updating the tracking record responsive to validation of the end user's visit to the physical retail establishment;
responsive to the validation of the end user's visit, displaying to the retailer a redemption interface on the second computing device, the redemption interface manually collecting predetermined personal information about the end user to facilitate delivery of the stored value payment card to the end user;
responsive to collecting the predetermined personal information about the end user, automatically mailing the stored value payment card in an inactivated state to the end user;
updating the tracking record according to the predetermined personal information about end user received;
presenting a targeted placement survey on the first computing device, the survey querying the user for details regarding the end user's experience at the retail establishment;
responsive to completing the survey, automatically activating the stored value card;
updating the tracking according to the details received regarding the end user's experience at the retail establishment; and
enabling a concurrent separate online, targeting advertising campaign using the tracking record of the end user, modifying the targeted advertising campaign responsive to the interaction between the retailer and the end user based upon the tracking record received, wherein the modification to the advertising campaign directed to the end user is executed through the retailer interface.

2. The method of claim 1, wherein the retailer is a car dealership.

3. The method of claim 1 further comprising:
receiving an IP address of end user's computer to a computer based server;
comparing the IP address to a stored list of previous registered IP addresses;
displaying the offer on a graphical user interface presented on an internet browser interface, responsive to the comparison not resulting in a match.

4. The method of claim 1, further comprising:
moving the offer to a sidebar display on a graphical user interface presented on a browser interface, responsive to receiving end user input refusing the advertisement.

5. The method of claim 1, further comprising opening a new browser interface responsive to receiving end user input selecting the advertisement.

6. The method of claim 1, further comprising:
receiving a first name to a computer based server;
receiving a last name to the server;
receiving a phone number to the server;
receiving an e-mail address to the server;
comparing the user e-mail address to a stored list of registered e-mail addresses;
creating a unique redemption PIN, responsive to the comparison not resulting in a match;
associating the redemption PIN with end user first name, last name phone number and e-mail address;
presenting a redemption certificate on the graphical user interface.

7. The method of claim 6, further comprising sending an ADF XML email to a dealership CRM tool.

8. The method of claim 6, further comprising sending a message to the user, wherein the message contains more information about the redemption certificate and a link to the redemption certificate.

9. The method of validating the redemption PIN of claim 1, further comprising;
user physically going to a dealership with the redemption certificate;
dealership logging on to a computer based server;
receiving a user name and a unique redemption PIN to the server;
comparing the user name and the unique redemption PIN to a stored list of end user tracking record received from a self-user identification and redemption PINs;
selecting the user name and the unique redemption PIN, responsive to the comparison resulting in a match;
receiving a user's address where an incentive will be sent;
verifying user's address through the USPS web tools verification API;
ordering a stored value payment card for a specified amount through API integration with a stored value payment card processor.

10. The method of creating the stored value payment card of claim 9, further comprising:
setting up a dealer's account to a computer based server;
adding funds to the dealer's account;
receiving an indication to create the stored value payment card for a specified amount;
debiting the dealer's account for the specified amount;
tracking amount debited from the dealer's account;
sending a dealer message to the dealer when the dealer's account reaches a specified remaining amount;
wherein the dealer message contains a link to add funds to the dealer's account;
suspending the advertisement appearing on the graphical user interface when the dealer's account reaches zero remaining balance;
sending an indication to create the stored value payment card through API integration with a stored value payment card processor;
creating the stored value payment card.

11. Activation of the stored value payment card of claim 10, further comprising:
receiving the stored value payment card in the mail, wherein the stored value payment card contains an activation PIN with a customized URL;
inputting the customized URL into an internet browser interface;
inputting the activation PIN;
answering a question, wherein an answer must be selected prior to activation of the stored value payment card;
selecting an activate button displayed on a graphical user interface on an internet browser interface;
sending activate through an API call to a stored value payment card processor activating the stored value payment card.

12. The method of activating the stored value payment card of claim 11, wherein the activation PIN is the card number.

13. A system for inducing customers to visit a physical retail establishment to engage in a financial transaction, comprising:
a computer based server operable to:
display on a first computing device to an end user an offer to redeem a stored value payment card in exchange for an authenticated visit to the physical retail establishment;
automatically receive end user tracking information via the first computing device, the end user tracking including IP address information;
save the end user tracking information as a tracking record;
issue a unique redemption PIN to the end user identifying the end user with the tracking record through the first computing device;
display on a second computing device to a retailer at the physical retail establishment a retailer interface wherein the unique redemption PIN is validated confirming the end user's visit to the physical retail establishment;
update end user tracking record according to the end user's visit to the physical retail establishment;
receive the collection of predetermined personal information by mailing the stored value payment card to the end user;
update end user tracking record according to the predetermined personal information about end user received;
present a targeted placement survey on the first computing device, the survey querying the user for details regarding the end user's experience at the retail establishment;
receive completed survey and automatically activate the stored value card;
update the tracking record according to the details received regarding the end user's experience at the retail establishment; and
present a concurrent, separate targeted advertising campaign on the first computing device, the separate targeted advertising campaign associated with the retail establishment and the targeting achieved using the tracked information of the end user, targeted advertising campaign based upon the tracking record responsive to the interaction between the retailer and the end user based upon end user tracking record received, wherein the modification to the targeted advertising campaign directed to the end user is executed through the retailer interface.

14. The system of claim 13, wherein the server is operable to:
receive a first name to a computer based server;
receive a last name to the server;
receive a phone number to the server;
receive an e-mail address to the server;
compare the user e-mail address to a stored list of registered e-mail addresses;
creating a unique redemption PIN, responsive to the comparison not resulting in a match;
associate the redemption PIN with end user first name, last name phone number and e-mail address;
present a redemption certificate on the graphical user interface.

15. The system of claim 13, wherein the server is operable to:
receive the activation PIN;
receive a response to a question, wherein an answer must be selected prior to activation of the stored value payment card;
receive an indication to activate the stored value payment card;
send through an API call to a stored value payment card processor activating the stored value payment card.
